(19) United States
(12) Patent Application Publication
(10) Pub. No.: US 2011/0059203 A1
(43) Pub. Date: Mar. 10, 2011

(54) Process for Manufacturing a Sport Beer

(75) Inventors: Frank Fitzke, Berlin (DE); Jurgen Schober, Storkow (DE)

(73) Assignee: Double F GmbH for Distribution, Berlin (DE)

(21) Appl. No.: 12/872,558

(22) Filed: Aug. 31, 2010

(30) Foreign Application Priority Data
Sep. 1, 2009 (DE) 10 2009 039532.6

(51) Int. Cl. C12H 1/15; C12C 7/04; C12C 1/027; C12C 7/165

(52) U.S. Cl. 426/16; 426/592; 426/64

(57) ABSTRACT

The invention relates to a process for manufacturing a sport beer comprising addition of a malt enzyme before and/or after fermentation. This low-calorie sport beer is directed at physically active people, particularly as part of a body-conscious nutrition programme.

The invention relates to a process for manufacturing a highly fermented beer with reduced contents of utilisable carbohydrates (dry beer or diet beer). The beer according to the invention is also referred to as Sport Beer.

The process allows the manufacture of a highly fermented beer referred to as “German Dry” or “Dry Beer” which can be “brewed according to the German purity law from 1516”.

### INTRODUCTION

The advantage of the invention is particularly based on flexibility of use of highly concentrated malt enzyme solutions in conformance with the purity law, during the different stages of manufacturing the beer. Furthermore, the highly concentrated malt enzyme solutions used (malt enzyme preparations) for the different dosages can be of a different enzymatic composition and so that a malt enzyme effect which is gentle to the product (for example improved foam stability compared to other beers made with malt enzymes) is achieved with, at the same time, an increase in the degree of fermentation due to a substantial degradation in the starch and its decomposition products.

### DESCRIPTION

The process describes the manufacturing of a highly fermented beer with reduced contents of fermentable carbohydrates. Manufacturing takes place according to the currently valid provisions of the German purity law from 1516 through exclusive use of barley malt, water and hop (for example in the form of hop pellets and/or hop extract), while using a normal brewers' yeast strain. The high degree of fermentation is achieved through use of highly concentrated malt enzyme solutions (malt enzyme preparations) at different points in time during the beer manufacture.

The beer according to the invention has an apparent final degree of fermentation of about 100% and is thus significantly more fermented than a conventional beer (e.g. Pilsner type of brewing with an about 82% apparent final degree of fermentation). In this way the beer has strongly reduced contents of fermentable carbohydrates (determined as glucose after total hydrolysis) of <0.75 g/100 ml. A Pilsner type of beer or a light full beer, on the other hand, has utilisable contents of carbohydrates in the range of about 2.2 to 3.4 g/100 ml. The alcohol contents of the highly fermented beer at about 4.8 to 5.1% by volume is the same as that for a Pilsner type of beer. This is achieved through reduction of the original wort content to about 9.2% mas compared to a Pilsner type of beer (about 11 to 12% mas), without having to take any alcohol removal measures.

In a first aspect the invention relates to a process for manufacturing a malt enzyme solution, preferably with a 7 to 9 times higher enzyme concentration of α-amylases, β-amylases and limit dextrinases compared to a normal malt enzyme solution, in particular for manufacturing a beer with reduced contents of fermentable carbohydrates.

The concentration of the malt enzyme solution depends on the starting solution and the enzyme contents of the malt used. These can fluctuate very strongly, for example due to the effects of weathering, the type, the mash method used and the mash concentration or the storage conditions. Therefore use of the malt enzyme takes place according to the concentration in the malt extract according to the desired target degree of fermentation and the actual original wort concentration.

According to the invention the process comprises the following steps:
germination of the barley,
providing a malt for manufacturing a malt extract,
extracting the malt enzymes from the germinated malt,
microfiltrating the malt extract, and
concentrating the microfiltrated malt extract by means of ultrafiltration.

As part of this process it is preferred to implement ultrafiltration with a nominal separation limit of <105,000 Daltons. This occurs advantageously after a cross-flow filtration process which is known to a person skilled in the art.

It is preferred that the concentrated malt enzyme solution used in the process has a 7 to 9 times higher enzyme concentration as the starting malt enzyme solution.

The highly concentrated malt enzyme solution is preferably manufactured according to the process steps 1 to 4 described in the published patent application DE 102 41 647 A1. The malt enzyme solutions made according to this process are sold under the brand-name ferlazym®.

In contrast to the method described in DE 102 41 647 A1, concentration of the microfiltered malt extracts does not occur using a vacuum evaporator but rather as a concentration stage in an ultrafiltration system with a nominal separation limit of <105,000 Daltons, in particular after a cross-flow filtration process. This variant, which is a gentle one for manufacturing highly concentrated malt enzyme solutions, allows manufacturing biologically harmless products with significantly reduced enzyme losses compared to vacuum evaporation.

Also malt enzyme preparations made using other processes (see, for example, DE 37 86 636 T2, DE PS 42 34 392 or 187689 from the Swiss Confederation) can be used as biocatalysts for the enzymatic digestion according to this invention.

The malt enzyme solution obtained can be used, as part of the second aspect of this invention, in a process for manufacturing a dry, diet beer or sport beer. This low calorie sport beer is directed at physically active people, particularly as part of a body-conscious nutrition programme.

According to the invention, use of the (highly concentrated) malt enzyme solutions for beer manufacture is not only just during fermentation. Addition of the malt enzyme occurs much more in the brew house, that is during mashing, and/or for maturation and/or storing of the beer.

The principal option for the use of highly concentrated malt enzyme solutions has already been described in the published patent application DE 100 27 915 A1 (filing date May 31, 2000). In contrast with this, the (highly concentrated) malt extracts are not added exclusively in the present invention just for fermentation, but can already be used, as a first addition, in the processing step mashing. It is also possible to have staggered, that is multiple metering, of different malt enzyme solutions (e.g. α-amylase preparations and multi-enzyme preparations) or the same malt enzyme solution during the mashing and/or the fermentation and/or the beer maturation. The quoted patent exclusively provides for addition of multi-enzyme preparations.

Dosage of the highly concentrated malt enzyme solutions exclusively takes place according to the published patent application DE 100 27 915 A1 according to the original wort contents and the residual extracts to be set according to the dosage instructions given there.

However, experience gained over the last few years has shown that this dosage regime known from the state-of-the-art is often insufficient under practical conditions. Because of the very different process management taking place in the breweries there are different production-facility-specific dosage variants to choose from which were not yet known from the quoted patent application as a decisive factor for manufacturing highly fermented beers. These different dosage variants are used, according to this invention, both in the wort manufacture and during fermentation. Staggered dosages have shown themselves to be advantageous in the fermentation stage for strongly accelerated fermentation processes.

### Dosage Variant 1 (Main Dosage)

The highly concentrated malt extracts are dosed after the wort cooling to initiate fermentation according to customary practice used in a brewery.

Dosage Variant 2

In addition to dosage variant 1, highly concentrated malt extracts are added to optimise all amylolytic activities during the mashing stage in the temperature range from 50 to 56° C.

Dosage Variant 3

In addition to dosage variant 1, highly concentrated malt extracts are added to optimise the activities of α-amylases and β-amylases during the mashing stage in the temperature range from 60 to 62° C.

Dosage Variant 4

In addition to dosage variant 1, highly concentrated malt extracts are added to optimise the activities of α-amylase during the mashing stage in the temperature range from 60 to 62° C.

Dosage variants 2, 3 and 4 are additional measures which arise from the respective malt quality and which can be used individually or together in the process.

Also the changes in the quality of the barley and the malt which occur due to climatic changes, which were not yet state-of-the-art knowledge at the point in time of development of the patent applications DE 100 27 915 A1 and DE 102 41 647 A1, require variable dosage of malt enzymes which involve both the point in time of addition of the preparations and their composition.

The following preferred implementation of the process as part of the manufacturing of highly fermented dry beers according to the invention is described based on known state-of-the-art, technological experience and the known high fluctuations in the qualities of the malt.

The malt is stored and reduced to small pieces using a conventional process. Use of the malt is according to the type of beer to be manufactured.

The mashing process is based on a known mashing procedure (see Schöber J., “Untersuchungen zur Produktion eines Malzenzympräparates and dessen Applikation bei der Diätbierherstellung” 1998, GCA Verlag, Herdecke, ISBN 3-928973-43-6). The mashing procedure already allows one to obtain a high apparent final degree of fermentation during wort manufacture. This apparent final degree of fermentation is significantly greater than 90%. Schöber made the determination during his investigations that the mashing procedure is adequate to obtain that level of final degree of fermentation. Experience gained over the last few years has shown, however, that malts are arriving at the breweries for which the known special mashing procedure alone is no longer sufficient to obtain such a high final degree of fermentation due to the changed weather conditions. Therefore the following modified mashing procedure was developed for dry beer manufacturing and manufacturing highly fermented beers.

The malt is mashed in with water at about 62° C. and is then left to stand in the temperature range 62° C. to 64° C., and, if necessary, there is a further period of being left to stand at 66° C.

Cold water is then added to the mash and the mash is cooled in this way down to a temperature of 50° C. to 55° C. A further period of standing is integrated into the process management in this temperature range. In contrast to the procedure developed by Schöber, there is already addition of highly concentrated malt enzyme solutions during this period of standing. All amylolytic enzymes work in this temperature range and, in combination with the action of enzymes added together with the highly concentrated malt enzyme solution, force digestion of the starch and the starch degradation products (α-glucans).

This additional dosage has shown itself to be necessary due to the fluctuating qualities of the malts since, as already mentioned above, the mashing procedures previously described have shown themselves in a number of practical applications and investigations to be no longer capable of guaranteeing the desired high apparent final degree of fermentation. For example, in summers with high humidity levels, there are malts available which are low in extract or in summers with periods of severe drought there are malts available which are weak in enzyme content.

The effect of the additional amylolytic enzymes (such as limit dextrinase, α-amylase and/or β-amylase) is to promote digestion of starches into fermentable carbohydrates. It is not possible to state any generally valid dosage for the highly concentrated malt extract to be added to the mash since this dosage must be determined separately according to the respective raw material quality, the individual original wort content and the desired apparent final degree of fermentation.

The whole mash is then heated on the rest at 50° C. to 55° C. to 60° C. to 62° C. and left to stand at this point again. The main fermentation sugar maltose is generated during this period out of the previously made small pieces of starch and the later final degree of fermentation is set.

After heating again to a temperature range of 70° C. to 74° C., the degradation of the α-glucans known in normal practise is performed up to the saccharification time (iodine-normality) during a further period of standing. There is the possibility, also during this standing period or during the heating period up to 70° C. to 74° C., to again add a highly concentrated malt extract and to promote degradation of the α-1,4 compounds of the α-glucans. This additional dosage and the associated digestion of starch degradation products promotes further rapid degradation of the α-glucans for an intensive fermentation management since it occurs before the drop in the pH value which occurs with the process of pre-fermentation and can therefore allow better use of the pH value unstable α-amylase in the process; this process should particularly be implemented when using malts from harvests which have a weak enzyme content.

The final mash pumping takes place after the last standing. This can occur after heating up to 76° C. to 78° C. or directly at the resting temperature. The latter can have a positive effect on degradation of the α-glucans since the α-amylases from the mash and the α-amylases dosaged with the highly concentrated malt enzyme solution can still work during purification and in the wort pan until heating occurs. All other enzymes are not so temperature stable and are already deactivated above 70° C.

The processing stages purification and wort cooking, hot break separation and wort cooling are performed according to methods used in a brewery which are well known to a person skilled in the art.

Highly fermented beers have an apparent final degree of fermentation in the area of 100% and more. When the (fermentable carbohydrates) contents go below <0.75 g/100 ml then these beers fulfill the requirements of the diet beer regulations in the Federal Republic of Germany. Even when using additional highly concentrated malt extracts during the mashing process, setting of such a high degree of fermentation “just by means of the wort manufacture” is not possible. One limiting factor here is the low concentration of limit dextrinase which degrades the α-1,6 compounds during the mashing and the fact that about 80% of the limit dextrinase is bound to a carrier protein. These enzymes are only released when the pH value has dropped through the effect of cystein proteinase and can therefore only be freely deployed during the fermentation and maturation stages.

Therefore, during manufacturing diet beers in Germany, malt extracts or crushed malt is dosaged for fermentation and the enzymatic degradation/digestion processes started again. An alternative is offered through use of highly concentrated malt enzyme solutions (malt enzyme concentrates). Concrete suggestions are offered in the published patent application DE 100 27 915 A1 for dosage of malt enzyme concentrates. These recommendations are, however, outdated from today's point of view. It is, in particular, intensive fermentation processes but also use of cylindrical-conical fermentation vessels which show that the dosages mentioned in the above-mentioned patent application, which were determined using small sized equipment have not proven themselves to be useful in practise.

Therefore, according to this invention, modified malt enzyme dosages have been developed for fermentation and maturation according to the technological conditions. In one embodiment of the invention a number of additions of malt enzymes are made for fermentation and maturation.

Once the fermentation and maturation processes have been completed the beers are stabilised, filtered and bottled according to the processes typically used in practise. An important point is that pasteurisation takes place in the form of high temperature heating for a short period of time or bottle pasteurisation. This is the only way to deactivate any still active enzymes and to stop any further degradation of the beer contents such as residual glucans and proteins.

The fact that the highly concentrated malt enzyme solutions are exclusively manufactured from malt and water, that they are furthermore produced in a brewery and also filtered using a multi-stage cross-flow filtration process without any use of filter aids or other reagents and subsequently concentrated, means that they meet the standards of the German purity law.

1. A process for manufacturing a beer, in particular a sport beer, comprising the following step:
addition of a malt enzyme before and/or after fermentation.

2. The process according to claim 1 wherein addition takes place during mashing and/or during maturation/storage.

3. The process according to claim 1 wherein the malt enzyme comprises limit dextrinase, α-amylase and/or β-amylase.

4. The process according to claim 3 wherein the malt enzyme is a pure α-amylase preparation, in particular for promotion of the degradation of the α-glucans during the mashing in the pH range above pH=5.2.

5. The process according to claim 1 wherein a β-glucanase-free or strongly β-glucanase reduced multi-enzyme preparation with α-amylase activity, β-amylase activity and limit dextrinase activity is used which is exclusively made out of malt and water and which is added during the mashing and for fermentation/maturation.

6. The process according to claim 1 wherein a protease-free and β-glucanase-free α-amylase malt enzyme solution is added for optimisation of the foam stability when activating the wort with yeast.

7. A beer which can be manufactured using a process according to claim 1.

8. A process for manufacturing a concentrate of a malt enzyme solution, in particular for manufacturing a beer, in particular a beer with reduced contents of utilisable carbohydrates comprising the following steps:
germination of the barley,
providing a malt for manufacturing a malt extract,
extracting the malt enzymes from the germinated malt,
microfiltrating the malt extract, and
concentrating the microfiltrated malt extract by means of ultrafiltration.

9. The process according to claim 8 wherein the ultrafiltration is performed with a nominal separation limit of <105,000 Daltons, in particular after a cross-flow filtration process.

10. The process according to claim 8 wherein the highly concentrated malt enzyme solution has a 7 to 9 times higher enzyme concentration than the unconcentrated mash/malt enzyme solution.

11. The process according to claim 2 wherein the malt enzyme comprises limit dextrinase, α-amylase and/or β-amylase.

12. The process according to claim 2 wherein a β-glucanase-free or strongly β-glucanase reduced multi-enzyme preparation with α-amylase activity, β-amylase activity and limit dextrinase activity is used which is exclusively made out of malt and water and which is added during the mashing and for fermentation/maturation.

13. The process according to claim 3 wherein a β-glucanase-free or strongly β-glucanase reduced multi-enzyme preparation with α-amylase activity, β-amylase activity and limit dextrinase activity is used which is exclusively made out of malt and water and which is added during the mashing and for fermentation/maturation.

14. The process according to claim 4 wherein a β-glucanase-free or strongly β-glucanase reduced multi-enzyme preparation with α-amylase activity, β-amylase activity and limit dextrinase activity is used which is exclusively made out of malt and water and which is added during the mashing and for fermentation/maturation.

15. The process according to claim 2 wherein a protease-free and β-glucanase-free α-amylase malt enzyme solution is added for optimisation of the foam stability when activating the wort with yeast.

16. The process according to claim 3 wherein a protease-free and β-glucanase-free α-amylase malt enzyme solution is added for optimisation of the foam stability when activating the wort with yeast.

17. The process according to claim 4 wherein a protease-free and β-glucanase-free α-amylase malt enzyme solution is added for optimisation of the foam stability when activating the wort with yeast.

18. The process according to claim 5 wherein a protease-free and β-glucanase-free α-amylase malt enzyme solution is added for optimisation of the foam stability when activating the wort with yeast.

19. The process according to claim 9 wherein the highly concentrated malt enzyme solution has a 7 to 9 times higher enzyme concentration than the unconcentrated mash/malt enzyme solution.
